(19) United States
(12) Patent Application Publication
(10) Pub. No.: US 2009/0159525 A1
(43) Pub. Date: Jun. 25, 2009

(54) Disposable Filter Cartridge for Espresso Coffee Machines

(75) Inventors: Carlo Rosa, Lecco (IT); Alessandro Ostuni, Empoli (IT)

Correspondence Address: BIRCH STEWART KOLASCH & BIRCH, PO BOX 747, FALLS CHURCH, VA, 22040-0747, US

(73) Assignee: ARIETE S.p.A., Campi Bisenzio (IT)

(21) Appl. No.: 12/083,641

(22) PCT Filed: Oct. 2, 2006
(86) PCT No.: PCT/EP2006/066971

§ 371 Date: Jul. 14, 2008

(30) Foreign Application Priority Data
Oct. 19, 2005 (IT) GE2005U000010

(51) Int. Cl. B01D 27/08

(52) U.S. Cl. 210/477

(57) ABSTRACT

Disposable filter cartridge for espresso coffee machines. The cartridge has a body with a height of 25.6 mm, calculated from the top of its filling end (A) to the opposite end (B) for discharging the coffee, said body in turn being composed of a cylindrical part (C) with a height of 17.5 mm which is connected to an oval-shaped part (D) truncated at the end, the outer diameter of the cylindrical part (C) being 35 mm, said cylindrical part (C) being connected via a curved wall part (D) having a radius of curvature of 16 mm to the bottom part (B) which has in turn an outer diameter of 18.5 mm.

The present invention relates to disposable filter cartridges for espresso coffee machines, and in particular to cartridges of the type described in the Italian patent application No. GE2005A000029 filed on 22 Apr. 2005 in the name of the same Applicant, which comprise a coffee powder containing body provided on the coffee powder filling side with a first filter and on the side where the coffee infusion is discharged with a second filter and in which the coffee powder containing body on the side where the coffee infusion is discharged comprises an oval-shaped cap part.

During the course of experiments carried out on numerous prototypes of these filter cartridges, it has been found that the best results for formation of the infusion were obtained with a cartridge having precise dimensions.

The object of the present model is therefore to provide a disposable filter cartridge for espresso coffee machines, the larger diameter of which, at the cartridge filling end, is 35 mm and the body of which, with a height of 25.6 mm, has, starting from the filling end, a cylindrical part with a height of 17.5 mm which is connected to an oval-shaped part truncated at the end and terminating in a flattened area with a diameter of 18.5 mm which supports the perforated filter for discharging the coffee infusion.

Further characteristic features of the filter cartridge according to the present invention will emerge more clearly during the course of the following description thereof, provided with reference to the accompanying drawings, in which:

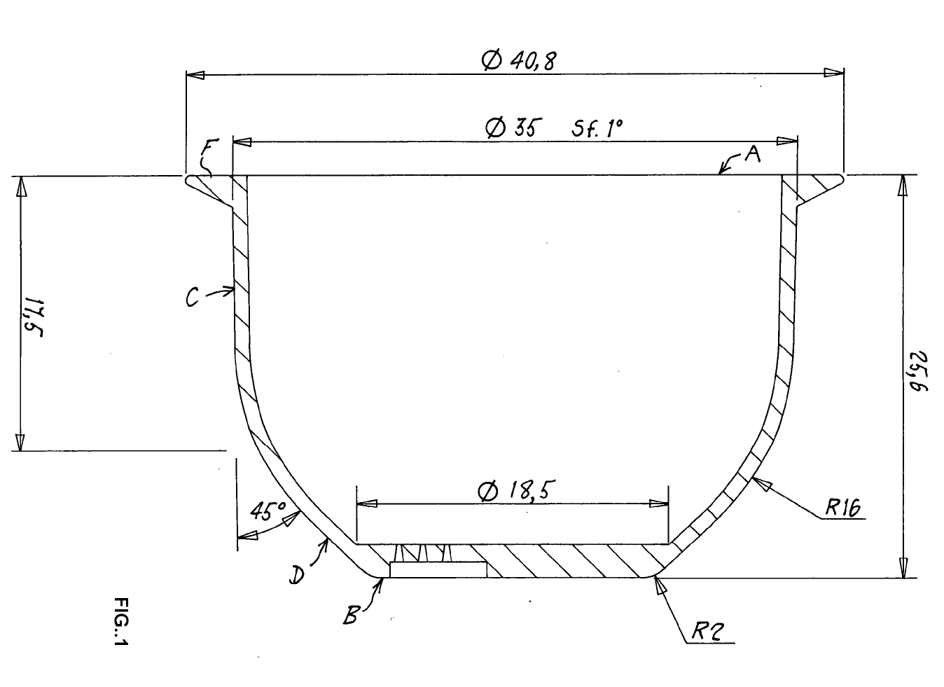

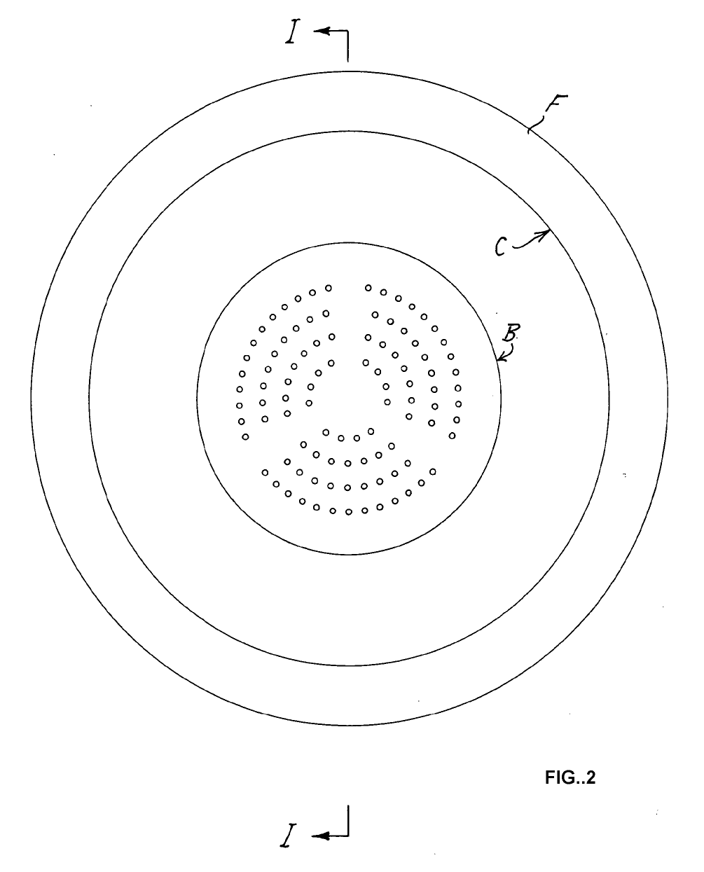

FIG. 1 is a diametrally cross-sectioned view, on a larger scale, along the plane of the line I-I shown in FIG. 2, of the cartridge according to the invention,

FIG. 2 is a plan view, from above, of the cartridge shown in FIG. 1, and

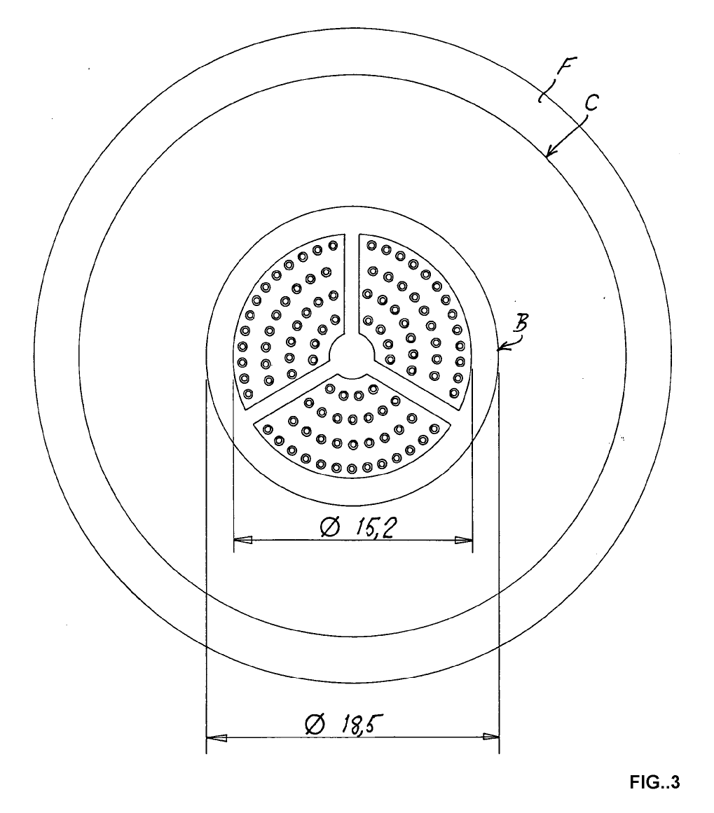

FIG. 3 is plan view, from below, of the cartridge according to FIG. 1.

With reference to the drawings, the body of the disposable filter cartridge for espresso coffee machines has a height of 25.6 mm, calculated from the top of its filling end A to the opposite end B for discharging the coffee. Said body in turn comprises a cylindrical wall part C with a height of 17.5 mm which is connected to an oval-shaped wall part D truncated at the end and terminating in the part B for discharging the coffee. The outer diameter of the cylindrical part C is 35 mm and this cylindrical part is connected via a circle arc with a radius 16 mm to the bottom part B which has in turn an outer diameter of 18.5 mm. The top end of the filter cartridge has an annular flange F with an outer diameter of 40.8 mm. The bottom of the cartridge has a whole series of small holes which are distributed over an area with a diameter of 15.2 mm.

Obviously, small differences in the measurements indicated are permissible in keeping with tolerance standards.

1. Disposable filter cartridge for espresso coffee machines, characterized in that it has a body with a height of 25.6 mm, calculated from the top of its filling end (A) to the opposite end (B) for discharging the coffee, said body in turn being composed of a cylindrical part (C) with a height of 17.5 mm which is connected to an oval-shaped part (D) truncated at the end, the outer diameter of the cylindrical part (C) being 35 mm, said cylindrical part (C) being connected via a curved wall part (D) having a radius of curvature of 16 mm to the bottom part (B) which has in turn an outer diameter of 18.5 mm.

2. Cartridge according to claim 1, in which the top end of the filter cartridge has an annular flange (F) with an outer diameter of 40.8 mm.

3. Filter cartridge according to claim 1, in which the bottom of the cartridge has a whole series of small holes which are distributed over an area with a diameter of 15.2 mm
